(19) United States
(12) Patent Application Publication
(10) Pub. No.: US 2004/0000787 A1
(43) Pub. Date: Jan. 1, 2004

(54) Authentication mark for a product or product package

(76) Inventors: Rakesh Vig, Durham, CT (US); Richard Selinfreund, Guilford, CT (US); Peter Miller, New London, CT (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/356,387

(22) Filed: Jan. 31, 2003

Related U.S. Application Data
(63) Continuation-in-part of application No. 09/556,280, filed on Apr. 24, 2000.
(60) Provisional application No. 60/416,843, filed on Oct. 8, 2002.

(51) Int. Cl. B42D 15/00

(52) U.S. Cl. 283/113

(57) ABSTRACT

The invention relates to an authentication mark for application to a product or product packaging that allows a consumer to at least partially determine whether the product or product packaging is authentic. The authentication mark comprises a first image that a consumer can change between a first state and a second state. The mark may also include a second image, which may only be verified by using a detection device. The first and second images, may be applied in one or more locations on the product or product packaging and may completely overlie or partially intersect one another or be on distinct portions of product or product package.

### RELATED APPLICATIONS

This application claims the benefit of co-pending U.S. Patent Application Serial No. 60/416,843, filed Oct. 8, 2002.

### FIELD OF THE INVENTION

This invention relates to authentication devices and methods, and more particularly, to an authentication mark to aid in authenticating products or product packaging.

### BACKGROUND OF THE INVENTION

Brand identity plays an important role in the marketplace. It provides a means for consumers to identify and rely on products coming from a particular source. It also provides a means for companies to attract and build goodwill with customers, thereby encouraging repeat business. Companies therefore spend billions of dollars on advertising and product development to establish such brand identity.

The benefits of and the resources expended on brand identity create powerful incentives for counterfeiters. Among the most prevalent illicit and illegal practices threatening brand identity are counterfeiting of the product itself, counterfeiting or theft of the package or container for use with an authentic or counterfeit product, or diversion of the product wherein the product manufactured for sale in a certain market is purchased by an intermediary in that designated market and sold in a competing market.

Such practices result in significant damage to the owner of the brand including lost sales, tarnished consumer perception of the brand, and liability due to claims made on counterfeit products. For example, the International Anti-Counterfeiting Coalition estimates that global revenue lost due to counterfeiting is as high as $200 billion per year. In addition, labeling industry estimates suggest that counterfeiting accounts for more than 10% of the world trade. Finally, pharmaceutical companies estimate that they are losing approximately $500 million in lost sales in India alone due to imitation drugs.

In addition to injury to brand identity, rights to copyrighted works may also be compromised by unauthorized reproduction of copyrighted material.

### SUMMARY OF THE INVENTION

To offer some level of authentication to verify whether a product or its package is authentic, manufactures employ a variety of techniques including the use of holograms, watermarks, and embossed marks, to name a few. One problem with these types of authentication marks is that they are relatively easy for a counterfeiter to reproduce. Visible markings, which can be seen by the consumer, can also be seen and reverse engineered by any individual intent upon producing a counterfeit product. Invisible or less visible marks, which can not be readily or easily seen by a consumer, make counterfeiting more difficult, but offer obstacles of their own. For example, an invisible mark does nothing to instill a sense of security in the consumer. Also, most invisible marks being used today can easily be found by using a black light, enabling a counterfeiter to detect and ultimately reproduce the mark or counterfeit products or product packages.

One solution to this problem is to employ a mark that is both detectable and verifiable by the consumer and which is not easily reproduced. In addition, an invisible mark may also be used, enabling a professional to verify the product or product package. By combining two types of marks on a product or product package, it is more difficult for a counterfeiter to copy.

In one illustrative embodiment, an authentication mark to be applied to a substrate for aiding in the determination of whether the substrate is authentic is disclosed. The authentication mark includes a first image, which includes a first compound. The first compound is adapted to be altered by a consumer between at least a first state and a second state, wherein a change from the first state to the second state suggests that the substrate is authentic.

In another illustrative embodiment, an authentication mark to be applied to a substrate for aiding in the determination of whether the substrate is authentic is disclosed. The authentication mark includes a first image, which includes a first compound, and a second image, which includes a second compound. The first compound is adapted to be altered by a consumer between at least a first state and a second state, wherein a change from the first state to the second state suggests that the substrate is authentic. The first compound is visible to the naked eye in at least one of the first and second states. The second compound is not visible to the naked eye.

In another illustrative embodiment, a method of authenticating a substrate having an authentication mark on the substrate, wherein a consumer can perform at least a portion of an authentication, is disclosed. The mark includes a first image, wherein a first compound is used to create at least a portion of the first image. The first compound is adapted to be altered by a consumer between at least a first state and a second state. The method includes viewing the first image when the first compound is in the first state, changing the first compound from the first state to the second state, viewing the first image when the first compound is in the second state, and determining whether the mark is authentic based on a change between the first and second states.

In another illustrative embodiment, an authentication mark to be applied to a substrate for aiding in the determination of whether the substrate is authentic includes a first image comprising a hologram and a second image comprising a compound. The second image is not visible to the naked eye.

### BRIEF DESCRIPTION OF THE DRAWINGS

Various embodiments of the present invention will now be described, by way of example, with reference to the accompanying drawings, in which:

FIG. 1 is a representation of one embodiment of an authentication mark according to the present invention;

FIG. 2 is a representation of the authentication mark in FIG. 1 when in an altered state;

FIG. 3 is a representation of the authentication mark in FIG. 1 as viewed through an authentication device;

FIG. 4 is a representation of another embodiment of an authentication mark according to the present invention;

FIG. 5 is a representation of the authentication mark in FIG. 4 when in an altered state;

FIG. 6 is a representation of the authentication mark in FIG. 4 as viewed through an authentication device;

FIG. 7 is a representation of another embodiment of an authentication mark according to the present invention; and

FIG. 8 is a representation of a counterfeit mark.

### DETAILED DESCRIPTION

The invention is directed to an authentication mark for application to a product or product packaging that allows a consumer to at least partially determine whether the product or product packaging is authentic. The authentication mark comprises a first image that a consumer can change between a first state and a second state. The change from the first state to the second state suggests to the consumer that the product or product packaging is authentic. To enable a second form of authentication, the mark may also include a second image, which may be invisible to the consumer and may only be verified by using a detection device. The first and second images, may be applied in one or more locations on the product or product packaging and may completely overlie or partially intersect one another or be on distinct portions of product or product package.

The state change can be any sensory change (e.g. visual, tactile, olfactory) as the present invention is not limited in this respect. In one embodiment, the state change may be an appearance and the condition necessary to change the appearance may be a temperature change, a change in lighting, a change in view angle or any other suitable condition, as the present invention is not limited in the respect.

In one embodiment, the first image may include a first compound that may be altered by a consumer between at least the first state and the second state. The first compound may be any suitable compound having consumer changeable states. The ability of the first compound to change from the first state to the second state suggests to the consumer that the substrate is authentic.

In another embodiment, the second image comprises a second compound. The second compound, which may be a light-sensitive compound, may not be visible to the consumer because it absorbs or emits wavelengths outside the visible spectrum in response to an irradiating light. The second image may be verified by using a detection device that can detect the response of the irradiated compound such as a wavelength of light outside the visible spectrum. Although embodiments are described as comprising a second image with a second compound, the present invention is not limited in this respect, as only the first image with the first compound as described above may be employed.

Light-emissive compounds emit light in response to irradiation with light. Light emission can be a result of phosphorescence, chemiluminescence, or, more preferably, fluorescence. Specifically, the term “light-emissive compounds,” as used herein, means compounds that have one or more of the following properties: 1) they are a fluorescent, phosphorescent, or luminescent; 2) react, or interact, with components of the sample or the standard or both to yield at least one fluorescent, phosphorescent, or luminescent compound; or 3) react, or interact, with at least one fluorescent, phosphorescent, or luminescent compound in the sample product, the standard, or both to alter emission at the emission wavelength.

Light-absorbing compounds absorb light in response to irradiation with light. Light absorption can be the result of any chemical reaction known to those of skill in the art. Thus, the present invention may be discussed below with reference to emission of light in response to irradiation with light, however, the present invention is not limited in this respect and light-absorbing compounds may be used.

Thus, as used herein, the tern “light-sensitive compounds” refers to both light emissive compounds as well as light absorbing compounds.

The term “fingerprint,” as used herein, means light emission or absorption intensity and/or intensity decay at a particular wavelength or range of wavelengths, from one or more light-sensitive compounds in combination with a standard (e.g., authentic) product or product package. Accordingly, each product or product package can have a particular fingerprint.

The term “authentic” or any derivative thereof, means an identification as being genuine or without adulteration or identification of point of origin or other desired information.

The term “fingerprint profile,” as used herein, means an assembly of fingerprints of a standard in combination with a series (or profile) of different light-sensitive compounds.

The term “sample characteristic,” as used herein, refers to the light emission or absorption quantity or intensity and/or intensity decay or change in quantity from one or more light-sensitive compounds in the ink on a sample product or product package.

The term “substrate” refers to any surface onto which an ink may be applied.

The tern “invisible” means invisible to the naked eye.

The term “readable image” is an image that conveys information when read by a human or a machine. Examples include, but are not limited to, numbers, letters, words, logos, and bar codes.

The “visible” range is 400-700 nm.

The “UV” range is 40-400 nm.

The “IR” range is 700-2400 nm.

The “near IR” range is 650-1100 nm.

To allow-a consumer to detect the change between the first state and the second state, in one embodiment, the first image may change from a first appearance to a second appearance. When the first image is in the First state, the first image may have a first appearance. When in the second state, the first image may have a second appearance. The first appearance may be different from the second appearance. The difference may include a change in color, pattern, level of visibility, level of intensity, any other visibly detectable change, or any combination thereof, as the present invention is not limited in this respect. For example, under a first condition, the first image may appear blue, but under a second condition, the first image may appear invisible. In addition or alternatively, under the first condition, the first image may not glow or not visibly emit light, but under the second condition, the first image may glow or visibly emit light.

In another embodiment, the state change may be a change in a tactile property of the mark, such as temperature or topography. For example, under a first condition, the mark may be cool to the touch whereas under a second condition, the mark may be warm to the touch. In a further embodiment, the state change may be an olfactory difference; for example, the first compound may emit a certain odor when in one state and not the other.

To change the state, the first image may be exposed to different conditions. These conditions may include temperature, wavelength of light, intensity of light, variations thereof, or any other conditions that may change the state, as the present invention is not limited in this respect.

As indicated above, the first image may include a first compound. By exposing the first compound to different temperatures, the first image may change appearance. For example, if the first image has a first appearance at a first temperature and a second appearance at a second temperature, the consumer will take comfort or otherwise know that the substrate is authentic. Any compound that is temperature sensitive, such as a thermochromic compound, may be used as such compounds enable the image to have a different appearance at the first temperature than at the second temperature.

Any two or more temperatures, at which the first image may have differing appearances, may be used. In one embodiment, where the first temperature occurs at room temperature, approximately 18-23° C., the second temperature may be higher than approximately 23° C. or lower than approximately 18° C. It should be appreciated that the first temperature need not be room temperature and that both the first and second temperature may be any temperature to which the first compound may be exposed, as the present invention is not limited in this respect. Although in some instances the difference between the two temperatures may be a fraction of a degree, the difference between the two temperatures may be 2-3° C. In one embodiment, liquid crystal technology may be applied, enabling a temperature difference of 1° C. or less to induce a change in appearance. It should be appreciated that depending upon the properties of the first compound, larger or smaller differences may be employed, as the present invention is not limited in this respect.

A consumer may change the temperature by exposing the first compound to a source of heat or a source of cold. In one embodiment, the first temperature may occur at room temperature and the second temperature may occur when the consumer places his/her finger over the first image, warming the compound through body heat. In another embodiment, the consumer may blow on the image, thereby lowering or raising the temperature of the compound.

In a further embodiment, external sources may be used to heat or cool the first compound. Examples of such sources include cold or hot water, an air conditioner, a heater, a cold or hot pack, a refrigerator, a freezer, an oven, or any other source of heat or cold. For example, the first image may be visible 30° C., but when the consumer places his/her thumb over the mark, thereby heating it over 31° C., the first image may disappear.

Examples of thermochromic compounds may be purchased from Color Change Corporation, located at 1545 Burgundy Parkway, Streamwood, Ill. 60107. These compounds may be adjusted such that their critical temperature, the temperature at which they may change from a first state to a second state, may range from −15° C. to 65° C. Additional examples of these compounds may be purchased from Matsui-Color Corporation, located at 1501 West 178^{th} Street, Gardena, Calif. 90248, under the trade name Chromicolor.

Another condition that may be used to change the first compound from the first state to the second state is the wavelength of light. Depending upon the wavelength of light, the first image may change from the first appearance to the second appearance. Examples of compounds that may change state depending upon the wavelength of incident light include photochromic compounds. These compounds may be purchased from Color Change Corporation, Spectra Group Limited, located at 1722 Indian Wood Circle, Suite H in Maumee, Ohio 43537, and Matsui-Color Corporation.

The difference between the first and second wavelengths of light should be significant enough such that the first wavelength induces a different appearance than the appearance induced by the second wavelength. In one embodiment, if the difference between the first and second wavelengths is 75 nm, then the first image may have a different appearance when the first compound is exposed to the first wavelength as compared to the second wavelength. It should be appreciated that any difference between the two wavelengths whether smaller than or greater than 75 nm, is intended to be within the scope of this invention, as the present invention is not limited in this respect.

The consumer may expose the first image to a first wavelength, inducing the first appearance. Then the consumer may expose the first image to a second wavelength, thereby inducing the image to change to the second appearance. In one embodiment, the first image may appear to be invisible in room light, but when the consumer places the mark in a light of a different wavelength, the first image may appear visible because the first compound is fluorescent or phosphorescent. It should be appreciated that any wavelength of light may be used that is in the visible range or in the invisible range, as the present invention is not limited in this respect.

For the consumer's ease in changing the conditions, the light source may comprise a light that is located near the product on the shelf, at the register, at the scanning booth, or in another location. The light source may be portable, hand-held, fixed, or room light. To further facilitate changing the conditions, a manual or motion-activated switch may be located near the product to change the lighting in the room or on the shelf, inducing the first image to change appearance.

The light source may further include a filter to enable the same light to be used to create both sets of conditions. The filter may be a filter that deters certain wavelengths of light, such as a thin film or dye filter, a polarizing filter, a reflection filter, a high or neutral density filter, or any other type of filter. The filter may be used in any form, such as a filter that covers the light source or a light bulb, a hand-held film or device, wearable eyeglasses, or any other filtering means. The light source may be located anywhere, have any means of activation, and have any means of filtering, as the present invention is not limited in this respect.

In addition to changing the wavelength of light, a change of intensity of light may also induce an altered appearance of the first image. The first compound may have the first appearance when exposed to a first intensity of light and the second appearance when exposed to a second intensity of light. In one embodiment, the first compound may not visibly emit light when exposed to the intensity of normal room light, but when the intensity of light is decreased (e.g. the light is dimmed) or the intensity of light is increased, the first image may appear to emit light or glow. Any intensity of light may be used, but preferably, one intensity is brighter or more intense and the other intensity is dimmer or less intense, allowing for the emission of light from the first compound to be visible. The difference between the first and second intensities of light should be such that the emission of light from the first compound may be visible under one intensity, but not visible under the other intensity. It should be appreciated that the difference may be smaller or larger and may depend upon the first compound, as the present invention is not limited in this respect.

The consumer may change the intensity of light either by changing the light source or by altering the first image's exposure to the same light source. In one embodiment wherein the first image's exposure to the same light source is altered, a first image may not be visible in normal room light, but when the consumer cups his/her hands around the first image, creating a darker atmosphere, the first image may appear visible because it may be emitting light. Additionally, the consumer may alter the first image's exposure to the light source by covering the first image with a piece of clothing, a filter, or any other means.

In another embodiment, the first image may comprise one or more holograms or other scrambled indices. Thus, a consumer may verify the product or package by viewing the hologram. In this example, a change in the hologram occurs by changing the angle of incident light relative to the viewing angle. Other methods for changing the appearance of the hologram may be used, as the present invention is not limited in this respect.

In another embodiment wherein the light source is changed, an area near the product display may have an intensity of light that is lesser than the room light. The consumer may take the substrate and place it in this darker environment, allowing the consumer to see the first image. In addition or alternatively, a switch may be located near the product to dim, filter, or turn off or on the lighting. It should be appreciated that areas of lesser or greater intensities of light may be located near the product, at the register, at a viewing booth, or anywhere that is convenient for the consumer to view the first image, as the present invention is not limited in this respect.

In an alternative embodiment, the first compound's change of state may be indicated by an olfactory change. For example, when the first compound is exposed to a certain condition, the compound may emit an odor, indicating that the mark is authentic. The change of state may be induced by changing the temperature, wavelength of light or intensity of light, rubbing the mark, or any other method that would cause the first compound to emit a different odor. This embodiment may be particularly useful for situations where a consumer may not have use of his/her sight such that he/she could detect a visual change in the appearance of the first image, e.g. if the person was blind or was in a light-less environment.

In another embodiment that does not rely upon the consumer's visual perception, the first compound's change of state may be indicated by a tactile response. The tactile response may be a topographic change, such as a portion of the mark becoming raised or textured, a temperature change, such as the mark becoming warm or cool to the touch, or any other change that may be detected by touching, the mark.

Regardless of whether the change in state is a visual, tactile or olfactory change and such that the user can detect the difference between the two states, the first image may be detectable in at least one state, in more than one state, or in all the states.

To allow a professional to verify the authenticity of the product or product package, a second image that may not be detectable by the consumer may be applied. Although the first image may be visible to the consumer, a second authentication image may not be readily detectable by the consumer. The second image is defined as the portion of the mark that contains a second compound. As mentioned above, this second compound may be a light-sensitive compound that emits or absorbs wavelengths outside the visible spectrum in response to an irradiating light.

A wide variety of light-sensitive compounds may be used with the present invention such as those compounds described in commonly assigned co-pending U.S. patent application Ser. No. 09/556,280 which is hereby incorporated herein in its entirety. Further, any compounds that emit or are excited by light having a wavelength of about 300-2400 nm, and in one embodiment, 300-1100 nm, may be used. Groups from which the light-sensitive compounds may be chosen include, but are not limited to, inorganic pigments, organic compounds, photochromic compounds, photochromic compounds cross linked with various polymers, photochromic compounds encapsulated in polymers and thermally stable near infrared fluorophoric compounds copolymerized with an ester linkage.

Light-sensitive compounds of the present invention may be water dissipatable polyesters and amides such as the compounds disclosed in U.S. Pat. Nos. 5,292,855, 5,336,714, 5,614,008 and 5,665,151, each of which is hereby incorporated by reference herein.

In one embodiment, the near infrared fluorescent compounds are selected from the phthalocyanines, the naphthalocyanines and the squarines (derivatives of squaric acid). In these structures, Pc and Nc represent the phthalocyanines and naphthalocyanine moieties, covalently bonded to hydrogen or to the various metals, halometals, organometallic groups and oxymetals including AlCl, AlBr, AlF, AlOH, AlOR₅, AlSR₅, Ca, Co, CrF, Fe, Ge, Ge(OR₆), Ga, InCl, Mg, Mn, Ni, Pb, Pt, Pd, SiCl₂, SiF₂, SnCl₂, Sn(OR₆)₂, Si(OR₆)₂, Sn(SR₆)₂, Si(SR₆)₂, Sn, TiO, VO or Zn, where R₅ and R₆ are hydrogen, alkyl, aryl, heteroaryl, lower alkanoyl, or trifluoroacetyl groups.

X is oxygen, sulfur, selenium or tellurium. Y is alkyl, aryl, halogen or hydrogen and R is an unsubstituted or substituted alkyl, alkenyl, alkynyl.

—(X—R)m is alkylsulfonylamino, arylsulfonylainino, R₁ and R₂ are each independently selected from hydrogen, lower alkyl, lower alkoxy, halogen aryloxy, lower alkylthio, lower alkylsulfonyl, R₃ and R₄ are each independently selected from hydrogen, lower alkyl, alkenyl or aryl; n is an integer from 0-12; n₁ is an integer from 0-24, m is an integer from 4-16; m₁ is an integer from 0-16, provided that the sums of the n+m and n₁+m₁ are 16 and 24 respectively

In the compounds above, the structures may include at least one polyester reactive group to allow the compound to be incorporated into a polymeric composition and to be bound by covalent bonds.

The light-sensitive compounds of the invention may also include photochromic compound such as photochromic compound incorporated into a polymeric composition and photochromic compounds encapsulated to form microcapsules as described in U.S. Pat. No. 5,807,625, which is hereby incorporated by reference.

In one embodiment, these photochromic compounds are from three classes:

(i) Spiro-indolino-naphthoxazines.

(ii) Fulgides which are derivatives of bis-methylene succinic anhydride and fulgimides which are derivatives of bis-methylene succinic imide where the imide nitrogen may be substituted by alkyl, aryl or aralkyl.

(iii) Spiro(1,8a)-dihydroindolizines.

The light-sensitive compounds of the invention may also include microbeads labeled with organic/inorganic compounds as described in U.S. Pat. No. 5,450,190, which is hereby incorporated by reference.

Also useful as light-sensitive compounds with the present invention are the compounds or compound combinations described in U.S. Pat. No. 5,286,286, which is hereby incorporated by reference. These may include:

5,10,15,20-tetrakis-(1-methyl-4-pyridyl)-21H,23H-prophine tetra-p-tosylate salt;

5,10,15,20-tetrakis-(1-methyl-4-pyridyl)-21H,23H-porphine tetrachloride salt;

5,10,15,20-tetrakis-(1-methyl-4-pyridyl)-21H,23H-porphine tetrabromide salt;

5,10,15,20-tetrakis-(1-methyl-4-pyridyl)-21H,23H-porphine tetra-acetate salt;

5,10,15,20-tetrakis-(1-methyl-4-pyridyl)-21H,23H-porphine tetra-perchlorate salt;

5,10,15,20-tetrakis-(1-methyl-4-pyridyl)-21H,23H-porphine tetrafluoroborate salt;

5,10,15,20-tetrakis-(1-methyl-4-pyridyl)-21H,23H-porphine tetra-perchlorate salt;

5,10,15,20-tetrakis-(1-methyl-4-pyridyl)-21H,23H-porphine tetrafluoroborate salt;

5,10,15,20-tetrakis-(1-methyl-4-pyridyl)-21H,23H-porphine tetra-perchlorate salt;

5,10,15,20-tetrakis-(1-methyl-4-pyridyl)-21H,23H-porphine tetra-triflate salt;

5,10,15,20-tetrakis-(1-hydroxymethyl-4-pyridyl)-21H,23H-porphine tetra-p-tosylate salt;

5,10,15,20-tetrakis-[1-(2-hydroxyethyl)-4-pyridyl]-21H,23H-porphine tetrachloride salt;

5,10,15,20-tetrakis-[1-(3-hydroxypropyl)-4-pyridyl]-21H,23H-porphine tetra-p-tosylate salt;

5,10,15,20-tetrakis-[1-(2-hydroxypropyl)-4-pyridyl]-21H,23H-porphine tetra-p-tosylate salt;

5,10,15,20-tetrakis-[1-(-hydroxyethoxyethyl)-4-pyridyl]-21H,23H-porphine tetra-p-tosylate salt;

5,10,15,20-tetrakis-[1(2-hydroxyethoxypropyl)-4-pyridyl]-21H,23H-porphine tetra-p-tosylate salt;

5,10,15,20-tetrakis-[4-(trimethylammonio)phenyl]-21H,23H-porphine tetra-p-tosylate salt;

5,10,15,20-tetrakis-[4-(trimethylammonio)phenyl]-21H,23H-porphine tetrachloride salt;

5,10,15,20-tetrakis-[4-(trimethylammonio)phenyl]-21H,23H-porphine tetrabromide salt;

5,10,15,20-tetrakis-[4-(trimethylammonio)phenyl]-21H,23H-porphine tetra-acetate salt;

5,10,15,20-tetrakis-[4-(trimethylammonio)phenyl]-21H,23H-porphine tetra-perchlorate salt;

5,10,15,20-tetrakis-[4-(trimethylammonio)phenyl]-21H,23H-porphine tetrafluoroborate salt;

5,10,15,20-tetrakis-[4-(trimethylammonio)phenyl]-21H,23H-porphine tetra-triflate salt;

meso-(N-methyl-X-pyridinium)ₙ(phenyl)4-n-21H,23H-porphine tetra-p-tosylate salt, where n is an integer of value 0, 1, 2, or 3, and where X=4-(para),3-(meta), or 2-(ortho) and refers to the position of the nitrogen in the pyridinium substituent, prepared as described, for example, by M. A. Sari et al. in Biochemistry, 1990, 29, 4205 to 4215;

meso-tetrakis-[o-(N-methylnicotinamido)phenyl]-21H,23H-porphine tetra-methyl sulfonate salt, prepared as described, for example, by G. M. Miskelly et al. in Inorganic Chemistry, 1988, 27, 3773 to 3781;

5,10,15,20-tetrakis-(2-sulfonatoethyl-4-pyridyl)-21H,23H-porphine chloride salt, prepared as described by S. Igarashi and T. Yotsuyanagi in Chemistry Letters, 1984, 1871;

5,10,15,20-tetrakis-(carboxymethyl-4-pyridyl)-21H,23H-porphine chloride salt

5,10,15,20-tetrakis-(carboxyethyl-4-pyridyl)-21H,23H-porphine chloride salt

5,10,15,20-tetrakis-(carboxyethyl-4-pyridyl)-21H,23H-porphine bromide salt

5,10,15,20-tetrakis-(carboxylate-4-pyridyl)-21H,23H-porphine bromide salt, prepared as described by D. P. Arnold in Australian Journal of Chemistry, 1989, 42, 2265 to 2274;

2,3,7,8,12,13,17,18-octa-(2-hydroxyethyl)-21H-23H-porphine;

2,3,7,8,12,13,17,18-octa-(2-hydroxyethoxyethyl)-21H-23H-porphine;

2,3,7,8,12,13,17,18-octa(2-aminoethyl)-21H-23H-porphine;

2,3,7,8,12,13,17,18-octa-(2-hydroxyethoxypropyl)-21H-23H-porphine, and the like, as well as mixtures thereof.

Also suitable for use with the present invention are dansyl compounds, including: dansyl-L-alanine; a-dansyl-L-arginine; dansyl-L-asparagine; dansyl-L-aspartic acid; dansyl-L-cysteic acid; N,N′-di-dansyl-L-cystine; dansyl-L-glutamic acid; dansyl-L-glutamine; N-dansyl-trans-4-hydroxy-L-proline; dansyl-L-isoleucine; dansyl-L-leucine; di-dansyl-L-lysine; N-ε-dansyl-L-lysine; dansyl-L-methionine; dansyl-L-norvaline; dansyl-L-phenylalanine; dansyl-L-proline; N-dansyl-L-serine; N-dansyl-L-threonine; N-dansyl-L-tryptophan; O-di-dansyl-L-tyrosine monocyclohexylammonium salt; dansyl-L-valine; dansyl-γ-amino-n-butyric acid; dansyl-DL-a-amino-n-butyric acid; dansyl-DL-aspartic acid; dansyl-DL-glutamic acid; dansylglycine; dansyl-DL-leucine; dansyl-DL-methionine; dansyl-DL-norleucine; dansyl-DL-norvaline; dansyl-DL-phenylalanine; dansylsarcosine N-dansyl-DL-serine; N-dansyl-DL-threonine; N-α-dansyl-DL-tryptophan; dansyl-DL-valine dansyl-DL-α-aminocaprylic acid cyclohexylamine salt; (dansylaminoethyl)trimethylammonium perchlorate; didansylcadaverine; monodansylcadaverine; dansylputrescine; dansylspermidine; didansyl-1,4-diaminobutane; didansyl-1,3-diamino-propane; didansylhistamine, all available from Sigma Chemical Corp., St. Louis, Mo., and the like, as well as mixtures thereof.

Additional light-sensitive compounds may also include an organic/inorganic pigment as described in U.S. Pat. No. 5,367,005 or any compound or compound combination of phenoxazine derivatives as described in U.S. Pat. No. 4,540,595, which are hereby incorporated by reference.

Additional light-sensitive compounds of the present invention may be classified in one of the following four groups depending upon excitation and emission regions, as described in U.S. Pat. No. 4,598,205, which is hereby incorporated by reference.

(a) Excitation UV-Emission UV

(b) Excitation UV-Emission IR

(c) Excitation IR-Emission UV

(d) Excitation IR-Emission IR

Also useful with the present invention is any compound or compound combination of organic infrared fluorescing compound that is soluble in the ink vehicle disclosed in U.S. Pat. No. 5,093,147, which is hereby incorporated by reference. Such light-sensitive compounds include: (3,3′-Diethylthiatricarbocyanine Iodide); (3,3′-Diethyl-9,11-neopentylenethiatricarbocyanine Iodide); (1,1′,3,3,3′,3′-Hexamethyl-4,4′,5,5′-dibenzo-2,2′-indotricarbocyanine Iodide); (Hexadibenzocyanine 3); 1H-Benz[e]indolium, 2-[7-[1,3-dihydro-1,1-dimethyl-3-(4-sulfobutyl)-2H-benz[e]indol-2-ylidene]-1,3,5-hepatrienyl]-1,1-dimethyl-3-(4-sulfobutyl-, sodium salt; (3,3′-Diethyl-4,4′,5,5′-dibenzothiatricarbocyanine Iodide)(Hexadibenzocyanine 45); Benzothiazolium, 5-chloro-2[2-[3-[5-chloro-3-ethyl-2(3H)-benzothiazolylidene-ethylidene]-2-(diphenylamino)-1-cyclopenten-1-yl]ethyl]-3-ethyl-, perchlorate; (1,1′-Diethyl-4,4′-dicarbocyanine Iodide); Naphtho[2,3-d]thiazolium, 2-[2-[2-(diphenylamino)-3-[[3-(4-methoxy-4-oxobutyl)naptho[d]thiazol-2(3H)-ylidene-ethylidene]-1-cyclopenten-1-yl]ethenyl]3-(4-methoxy-oxobutyl)-, perchlorate

The following light-sensitive compounds may also be useful with the present invention:

Sulfuric acid disodium salt mixture with 7-(diethylamino)-4-methyl-2H-1-benzopyran-2-one; 3′,6′-bis(diethylamino)-spiro-(isobenzofuran-1(3H),9′-(9H)xanthen)-3-one or 3′,6′-bis(diethyl-amino)-fluoran; 4-amino-N-2,4-xylyl-naphthalimide; 7-(diethylamino)-4-methyl-coumarin; 14H-anthra[2,1,9-mna]thioxanthen-14-one; N-butyl-4-(butylamino)-naphthalimide.

In addition, the following compounds may also be used as light-sensitive compounds with the present invention: 5-(2-Carbohydrizinomethyl thioacetyl)-aminofluorescein; 5-(4,6-dichlorotriazinyl)-aminofluorescein; Fluor-3-pentammonium salt; 3,6-diaminoacridine hemisulfate, proflavine hemisulfate; Tetra(tetramethylammonium salt; Acridine orange; BTC-5N; Fluoresceinamine Isomer 1; Fluoresceinamine Isomer 11; Sulfite blue; Coumarin diacid cryptand[2,2,2]; Eosin Y; Lucifier yellow CH Potassium salt; Fluorescein isothiocyanate (Isomer I); Fluorescein isothiocyanate (Isomer II); Fura-Red, AM; Fluo-3 AM; Mito Tracker Green FM; Rhodamine; 5-carboxyfluorescein; Dextran Fluroscein; Merocyanine 540; bis-(1,3-diethylthiobarbituric acid trimethine oxonol; Fluorescent brightener 28; Fluorescein sodium salt; Pyrromethene 556; Pyrromethene 567; Pyrromethene 580; Pyrromethene 597; Pyrromethene 650; Pyrromethene 546; BODIPY 500/515; Nile Red; Cholesteryl BODIPY FL C12; B-BODIPY FL C12-HPC; BODIPY Type D-3835; BODIPY 500/510 C5-HPC; IR-27 Aldrich 40,610-4; IR-140 Aldrich 26,093-2; IR-768 perchlorate Aldrich 42,745-4; IR-780 Iodide Aldrich 42,531-1; IR-780 perchlorate Aldrich 42-530-3; IR-786 Iodide Aldrich 42,413-7; IR-786 perchlorate Aldrich 40,711-9; IR-792 perchlorate Aldrich 42,598-2; 5-(and-6)-carboxyfluorescein diacetate; 6-caroxyfluorescein Sigma; Fluorescein diacetate; 5-carboxyfluorescein diacetate; Fluorescein dilaurate; Fluorescein Di-b-D-Galactopyranoside; FluoresceinDi-p-Guanidinobenzoate; Indo I-AM; 6-caroxyfluorescein Diacetate; Fluorescein thiosemicarbazide; Fluorescein mercuric acetate; Alcian Blue; Bismarck Brown R; Copper Phthalocyanine; Cresyl Violet Acetate; Indocyanine Green; Methylene Blue; Methyl Green, Zinc chloride salt Sigma; Oil Red 0; Phenol Red Sigma; Rosolic Acid; Procion Brilliant Red; Ponta Chrome Violet SW; Janus Green Sigma; Toluidine Blue Sigma; Orange G; Opaque Red; Mercuric Oxide Yellow; Basic Fuchsin; Flazo Orange; Procion Brilliant Orange; 5-(and-6)-carboxy-2′,7′-dichlorofluorescein; 5-(and-6)-carboxy-4′,5′-dimethyl fluorescein; 5-(and-6)-carboxy-2′,7′-dichlorofluorescein diacetate; Eosin-5-maleimide; Eosin-5-Iodoacetamide; Eosin Isothiocyanate; 5-Carboxy-2′,4′,5′,7′-tetrabromosulfonefluorescein; Eosin thiosemicarbazide;

Eosin Isothiocyanate Dextran 70S; 5-((((2-aminoethyl)thio)acetyl)amino) fluorescein; 5-((5-aminopentyl)thioureidyl)fluorescein; 6-carboxyfluorescein succinimidyl ester; 5,5′-dithiobis-(2-nitrobenzoic acid); 5-(and-6)-carboxyfluorescein succinimidyl ester; Fluorescein-5-EX, succinimidyl ester; 5-(and-6-)-carboxy SNARF-1; Fura Red, Tetrapotassium salt; Dextran fluorescien, MW 70000; 5-(and-6-)-carboxynaphthafluorescein mixed isomers; Rhodol green, carboxylic acid succinimdyl ester; 5-(and-6-)-carboxynaphthafluorescein SE mixed isomers; 5-carboxyfluorescein, SE single isomer; 5-(and-6)-carboxy-2′,7′-dichlorofluorescein diacetate, SE; 5-(and-6)-carboxy-SNAFL-1, SE; 6-tetramethylrhodamine-5-and-6-carboxamido hexanoic acid, SE; Styryl Compound (4-Di-1-ASP); Erythrosin-5-isothiocyanate; Newport green, dipotassium salt; Phen green, dipotassium salt; Bis-(1,3-dibutylbarbituric acid0 trimethine oxonol; lucigenin(bis-N-methyl acridinium nitrate, tetrakis-(4-sulfophenyl) porphine; tetrakis-(4-carboxyphenyl) porphine; anthracene-2,3-dicarboxaldehyde, 5-((5-aminopentyl)thioureidyl) eosin, hydrochloride, N-(ethoxycarbonylmethyl)-6-methoxyquinolinium brimide; MitoFluor green; 5-aminocosin, 4′(aminomethyl)fluorescein; hydrochloride; 5′(aminomethyl)fluorescein, hydrochloride; 5-(aminoacetamido)fluorescein; 4′((aminoacetamido) methyl) fluorescein; 5-((2-(and-3)-S-(acetylmercapto)succinoyl)amino fluorescein; 8-bromomethyl-4,4-difluoro-1,3,5,7-tetramethyl-4-bora-3a,4a,diaza-s-indacene; 5-(and-6)-carboxy eosin; cocchicine fluorescein; Casein fluorescein, 3,3′-dipentyloxacarbocyanine iodide; 3,3′-dihexyloxacarbocyanine iodide; 3,3′-diheptyloxacarbocyanine iodide; 2′-7′-difluorofluorescein; BODIPY FL AEBSF; fluorescein-5-maleimide; 5-iodoacetamidofluorescein; 6-iodoacetamidofluorescein; Lysotracker green; Rhodamine 110; Arsenazo I; Aresenazo III sodium; Bismarck brown Y; Brilliiant Blue G; Carmine; b-carotene; Chlorophenol red; Azure A; Basic fuchsin; di-2-ANEPEQ; di-8-ANEPPQ; di-4-ANEPPS; and di-8-ANEPPS where ANEP(aminonaphthylethenylpyridinium).

The second image may be used in conjunction with one or more holograms or scrambled indices. In one embodiment, the changeable compounds of the second image may overlie, underlie or be arranged between layers forming the hologram. Alternatively, the second image may be spaced from the hologram.

Preferably, the second compound emits or absorbs wavelengths in the invisible spectrum. Thus, a detection device may be required to read the second image. Any detection device may be used to detect the second image, as the present invention is not limited in this respect.

In one embodiment, the detection device is a wand, as described in commonly assigned co-pending U.S. Patent No. 60/353,481, which is hereby incorporated herein by reference in its entirety. The wand may include an excitation light source(s), filters, and lenses. The wand may be moved across the substrate to be verified, or may be stationary, as desired. The excitation light source may excite the light-sensitive compound(s) of the second image to produce a response. The excitation light source may be either a coherent source, such as, but not limited to, a light-emitting diode (LED), or an incoherent source, such as, but not limited to, a laser diode (LD). Filters may also be employed to filter undesired wavelengths of either excitation light or emission light, or both. The detector is employed to detect light response from the light-sensitive compound, and may comprise, without limitation, a silicone photodiode. An indicator may be employed to indicate that the light-sensitive compound is verified or incorrectly applied.

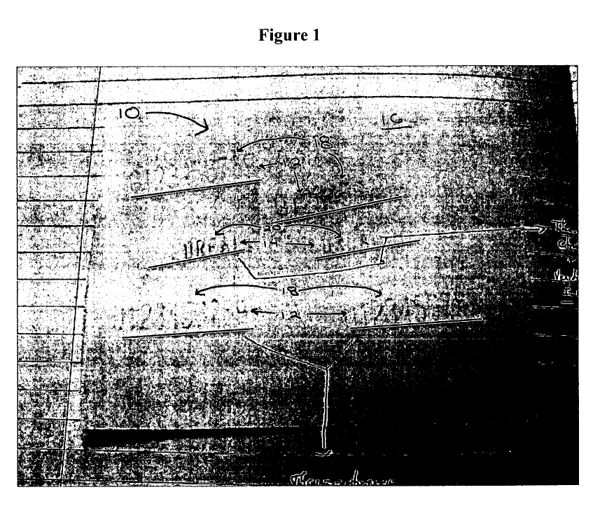

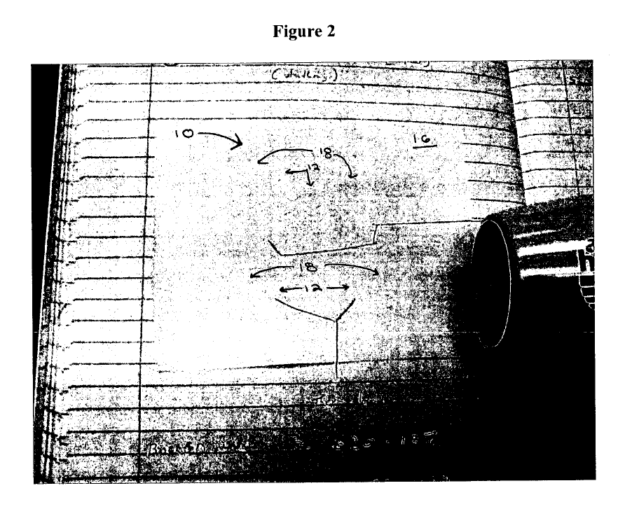

In another embodiment, the detection device may be constructed as a hand-held probe, such as described with reference to FIGS. 1 and 2 in commonly assigned co-pending U.S. patent application Ser. No. 09/556,280, which is hereby incorporated herein by reference in its entirety. The device may include similar components as described above. Briefly, in the FIGS. 1 and 2 embodiment of the '280 application, the verification device includes a hand-held probe assembly having a probe body, which may be a unitary body or may be formed with a plurality of discrete body parts. The probe body includes one or more light sources disposed therein. In a preferred embodiment, the light sources are provided by light-emitting diodes such as Model Number HLMP CB15 sold by Hewlett-Packard, California, USA, which may or may not be infrared light-emitting diodes or near infrared light-emitting diodes. In an alternative embodiment, the light source may be a laser light source. In either case, the light source emits light having an excitation wavelength of one or more light-sensitive compounds in the second image on the product or product packaging. The probe assembly may further include source filters, such as bandpass or cutoff filters, to isolate wavelengths of light from the light source. Lenses, such as symmetric convex lenses each having a 10 mm focal length with a 10 mm diameter, focus light emitted from the light sources and also focus light onto a detector. One or more prisms (not shown) may also be used to direct or focus light. One example of a detector is a charge couple device (CCD) Model Number H53308 sold by Edmund Scientific, New Jersey, USA. Other suitable detectors, such as a CMOS or PMT, may be employed. An emission filter, such as a bandpass or cutoff filter (or light absorption), is used to isolate excitation wavelengths from emission spectra due to light emission from the mark. A controller, such as a PALM PILOT®, may communicate with the probe assembly to compare the light response to a fingerprint.

In yet another alternative, the detection device may be constructed as a camera described with respect to FIGS. 15-19 of the above-mentioned co-pending U.S. patent application Ser. No. 09/556,280. Briefly, in the FIGS. 15-19 embodiment of the '280 application, the device includes components similar to those described above as well as a processor, such as a Fujitsu Teampad, coupled to an image capture system. The image capture system includes a signal processor, such as a digital signal processor (DSP), two detectors, such as that described above, and a flash control system, such as light source. One DSP that may be used is model 320C52 from Texas Instruments, Dallas, Tex. The processor also provides a number of functions such as providing a user interface, which may include a display. The processor also accepts the images from the DSP, processes the images to distinguish the background from the fluorescent image, and colors the image in pseudo-colors to enable the user to distinguish the background from the fluorescent image. The processor may employ a Windows 95 operating system, although other suitable operating systems may be employed. The excitation light source may be of any intensity and may last for any duration. Preferably, the light source is of a high intensity to increase the intensity of the emission wavelengths from the light-sensitive compounds so that the emission (or absorption) wavelengths can be resolved from background emission (or absorption). This may also allow for detection from more than 6 inches away. In this embodiment, the excitation light source is of sufficient intensity so that the resulting spectra may be measured at a distance, for example, up to 12 feet, without the need to compensate for background emission. In one embodiment, the spectra may be detected as a distance of up to four feet. In another embodiment, the spectra may be detected as a distance of up to six feet.

It is to be appreciated that any suitable device may be employed to read and verify the second image (i.e. detect emitted or absorbed light from the second compound), as the present invention is not limited in this respect. Thus, the particular devices described herein are exemplary only and not limiting. Detection of light absorbed from the light-absorbing compounds may be made using any suitable imaging technique. Similarly, detection of light emitted from the light-sensitive compounds may be made using any suitable imaging technique such as infrared, near infrared, far infrared, Fourier transformed infrared, Raman spectroscopy, time resolved fluorescence, fluorescence, luminescence, phosphorescence and visible light imaging.

It is to be appreciated that the particular light-sensitive compound or compounds applied to the product or product package may be selected based upon the light emitted from a standard optical scanner. In this regard, a particular light-sensitive compound or compounds may be used when printing the bar code on a product package or label that is capable of being scanned by a conventional scanner used at check-out counters at retail stores, for example. These scanners therefore can not only can read product information from the bar code, as is typically performed, but also can scan the product or product package for authenticity or other desired information generated by the light emission or absorption from the light-sensitive compound or compounds. Consequently, the detection device could be a scanner having properties similar to a conventional scanner used at checkout counters at retail stores.

As the mark, or first and second images, can be applied anywhere on the substrate, they can contain any type of information. As a way of communicating information about the product, its production or intended destination, the images may contain useful information. In one embodiment, this information may be production information such as production date, location, batch numbers and track and trace information. In another embodiment, this information may additionally or alternatively be brand or trademark identification, such as a portion of or an entire trademark, a name, a logo, a bar code, or any other identification that might be associated with the product. It should be appreciated that the first and second images need not contain the same information, different information, any information at all, or any combination of the above-exemplified information as the present invention is not limited in this respect.

Any suitable applicator may be used to apply at least a portion of, any or all of the compounds to the product or product package. In one embodiment, the applicator is a printer. Any type of printer can be used, such as a multi-color printing press, an ink jet printer, a dot matrix printer, silk screening or pad printing, as the present invention is not limited in this respect. Alternatively, at least a portion of, any or all of the compounds may be first applied to a decal or adhesive label, which is in turn applied to the substrate. Additionally, at least a portion of, any or all of the compounds may be sprayed on using, for example, an airbrush, an air gun or an aerosol-type spray. It should be appreciated that the first and second compounds need not be applied with the same applicator or with the same type of applicator, as the present invention is not limited in this respect.

In one embodiment, the printer prints one or more compound(s) mixed with an ink, which may or may not include a suitable solvent, to form at least a portion of the mark. Preferably, two compounds are used to create the mark but it is to be appreciated that any number of compounds can be used. The ink and/or compounds may be a visible ink or an invisible ink and in one embodiment is water insoluble. In one embodiment, the first compound may be mixed with a first ink. In addition, the second compound may be mixed with a second ink and the combination of these two inks may be used to form at least a portion of the mark. In another embodiment, the compounds are mixed with the same ink. In yet another embodiment, one compound is mixed with ink and the other compound is not mixed with ink.

The particular compound selected may have minimal impact on the visible characteristics of the ink so as not to be noticeably different than other printing on the package. For example, one or more compounds mixed with visible ink (such as black ink) are used to print information on the product package, such as the bar code.

In one embodiment, an ink jet printer is used. Using an ink jet printer may be advantageous because reservoirs having different compounds may be readily changed, for example, through a suitable communication link, depending upon the product, consumer, date and/or place of manufacture or any other desired data. In addition, ink jet printers are commonly used to print the bar code on a label or directly on the product or package itself. It is to be appreciated that at least a portion of, any or all of the compounds may be configured into any desired pattern ranging from a single dot that may convey no more information than what is contained in the ink formulation (i.e., mixed with the compound) to a bar code to a more complex pattern or alphanumeric code that may convey information, as described above, related to, for example, product, date, time, location, production line, consumer, etc.

In one embodiment, a continuous ink jet printer is employed. Using a continuous ink jet printer may offer some advantages, such as the ability to print the mark while the substrate is moving, such as on a production line which is described in U.S. patent application Ser. No. 10/275,456, which is hereby incorporated herein by reference in its entirety. For example, as product comes off the line, the compounds can be applied to each product package at a speed commensurate with the line speed of the production line. Of course, whether a continuous ink jet printer is used or not, the substrate may temporarily stop at a location adjacent the printer to allow at least a portion of, any or all of the compounds to be printed thereon.

Further, using a continuous ink jet printer allows at least a portion of, any or all of the compounds to be applied to the substrate when the substrate (e.g., the product packaging), includes the product. That is, when the product is already contained in the product packaging, it may not be feasible to utilize other printing techniques, such as silk screening. For example, silk screening tends to require high temperatures in order to apply indicia. Such high temperatures may have an adverse effect on the product contained within the packaging. In addition, applying at least a portion of, any or all of the compounds after the product is contained within the product packaging may be desirable for distribution purposes. That is, often times, products are made at a single product manufacturing plant but are designated for different channels of trade. A manufacturer may take a batch of product and print it or the package with the mark of the present invention in order to designate that product for a specific market.

Depending on the intended deterrent value of the mark, the location of both the first and second images may be important. At least a portion of any or all of the images of the present invention may be applied anywhere to a product or product package including on a package flap or inside the package itself.

To discourage tampering with the mark, it may be desirable for at least a portion of, any or all of the images to overlap another printed portion, especially a recognizable feature on the product or product package, because it may be more difficult to tamper with something that is desirable in a counterfeit product. Such printed portions may include those items that are particularly important to the sale of the product, for example, product name, trademark, logo, and company name. In one preferred embodiment, at least a portion of, any or all of the images may be placed on the same location on the package, as is the trademark of the product. In this manner, any attempt to remove at least a portion of, any or all of the images would also result in the destruction of the trademark on the package. At least a portion of, any or all of the images may be applied to the package as part of the ink formulation used to print the trademark itself or alternatively may be applied either under or over the printing of the trademark. Not only does this placement make it more difficult for the images to be removed, but it also provides an easy-to-locate target when checking to verify the presence of the images.

It may be desirable to inhibit removal of at least a portion of, any or all of the compounds. In this manner, the mark may be made tamper-resistant. Exemplary techniques that render a mark tamper-resistant, such as through the use of a UV curable overcoat, are described in the above-referenced U.S. patent application Ser. No. 10/212,334, which is herein incorporated herein by reference in its entirety. In one example, a sealer employed to render the mark tamper-resistant is mixed with the ink and any or all of the compounds and is therefore printed onto the substrate as the mark, or portion thereof, is being formed.

Further, it should be appreciated that the present invention is not intended to be limited by the substrate to which the mark may be applied. Any product or product package may be marked using this system. Examples of such products are caps (e.g. bottle caps), labels, paper, cardboard, glass, metal, plastics, rubber, bottles, cigarette packages, optical disks, such as CD's or DVD's (as described in commonly assigned co-pending U.S. patent application Ser. Nos. 09/608,886 and 09/631,585, each of which is hereby incorporated by reference in their entireties), jewelry, bank or credit cards, sports memorabilia, auto components or body parts, artistic prints, etc., as the present invention is not limited in this respect.

In one embodiment, the product packaging can be a plastic substrate, such as a container or bottle for a liquid product, such as shampoo, creams and the like. Such plastic materials may include high density polyethylene (HDPE), low density polyethylene (LDPE), polyethylene (PE), polypropylene, polycarbonate, and PETE. Other suitable substrates may be employed, such as metal, including tin and aluminum. Of course, it should be appreciated that the present invention is not limited in this respect and other suitable substrates may be employed.

It should be appreciated that the present invention is not limited to the use of a printing process. For example, a fiber of a product may be dipped into a compound and then woven into the material for use in clothing, luggage, book covers, carpeting, currency, prints or other artwork, and the like, such that when the material is exposed to a certain wavelength of light, temperature, intensity of light or other condition, or viewed under a detection device, as described above, the compound-dipped fiber, may either change state or emit or absorb a wavelength of light that is detectable by the detection device.

If the product does not lend itself to printing directly thereon, other methods of identifying and authenticating the product may be used. For example, the method described in commonly assigned U.S. patent application Ser. No. 09/232,324, which is herein incorporated by reference in its entirety, may be used.

### Examples

### Example 1

In this example, and as seen in FIG. 1, the mark (10) is formed with an ink comprising a first compound (12) and a second compound (14). The mark (10) is applied to a white paper substrate (16) using a hand stamp and a self inking pad. First messages (18), reading “0123456789”, are applied in four locations on the substrate (16) and second messages (20), reading “LOREAL”, are applied in two locations on the substrate (16).

The first messages (18) contain the first compound (12), which is a thermochromic dye that becomes colorless at 31° C. The second messages (20) contain the first compound (12) as well as the second compound (14).

As seen in FIG. 2 and when heated, such as by a hair dryer, the first image of the first compound (12) becomes invisible, rendering the first messages (18) and the second messages (20) undetectable to the naked eye. The ability of the first image from the first compound (12) to disappear by heating allows a consumer to verify at least partially that the substrate (16) is authentic by placing, for example, a finger over the messages (18, 20), heating with a hair dryer or any other heating means, and watching the messages (18, 20) disappear as they are warmed. The consumer is satisfied by the fact that under normal conditions, the messages (18, 20) are visible, but when heated become invisible. In one embodiment, the consumer is further satisfied that the messages (18, 20) revert to their initial appearances when the heat source is removed.

The presence of the second compound (14), which was added to the ink used to stamp the second messages (20), is detected using a detection device, as described above and in the '481 application. The device measures the background (22) at 620 units. When scanned across the first messages (18), the device detects 620 units. The device detects 1200 units when scanned across the second messages (20), thereby successfully verifying the presence of the second compound (14) in the second messages (20).

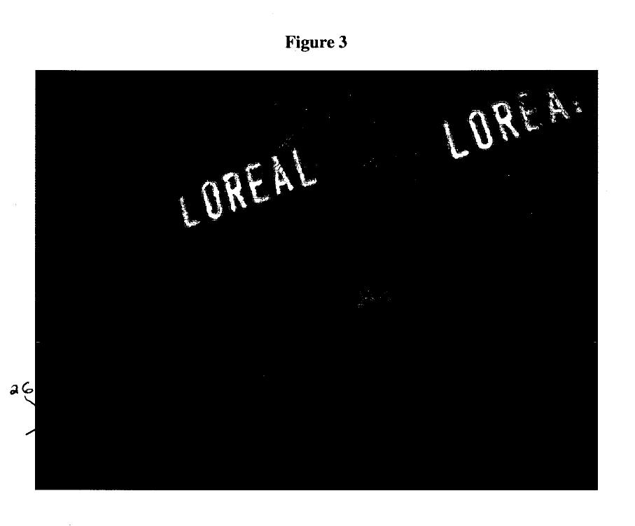

Alternatively, a camera, such as described above and in the '280 application, may be used to view the second messages (20). As seen in FIG. 3, which shows the substrate (16) as seen through the camera, the second image (24) is viewable. The second image (24) shows the second messages (20) because they contain the second compound (14).

The first messages (18) are not visible in the second image (24). An arrow (26) at the bottom left of FIG. 3 points to where one of the first messages (18) would be if the second compound (14) had been present in the ink used to print the first messages (18).

### Example 2

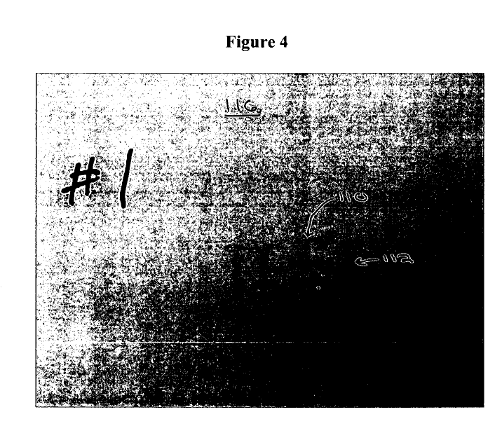

A second example of the present invention can be seen in FIGS. 4-6. A substrate (116) is imprinted (using an ink and a stamp) with a first compound (112) and a second compound (114). As seen in FIG. 4, the first compound (112) appears as a first image (110), reading “TEST”.

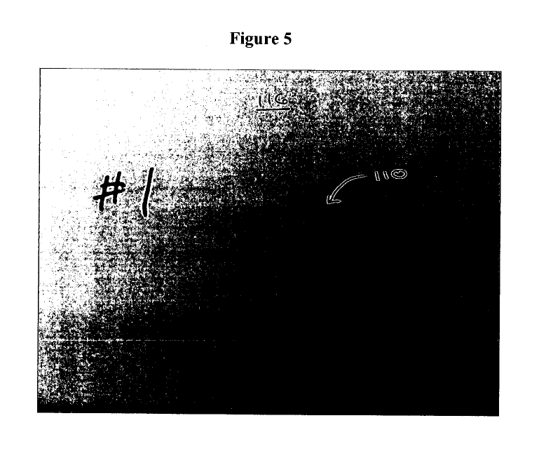

The first image (110) is thermally active. Heating causes the first compound (112) to activate, thereby causing the first image (110) to disappear. FIG. 5 is a picture taken while the substrate (116) is at an elevated temperature, hence the first image (110) is not visible.

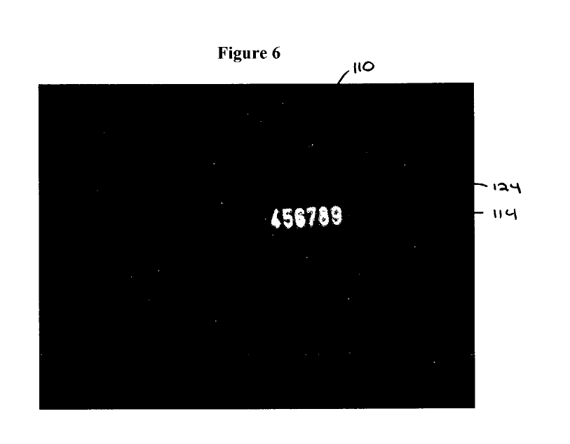

As seen in FIG. 6, which shows the substrate (116) as seen through the camera, a second image (124) is viewable using a camera, as described above. The second image (124) depicts the second compound (114) as printed as “456789”. When viewed through the camera, the second image (124) is visible. This second image (124) is located on the same portion of the substrate as the first image (110).

The combination of the two images (110,124) creates a secure and reliable method of authentication and tracking. The first image (110) provides a sense of security to the consumer who may verify its thermal activity, while the camera's ability to read the second image (124) provides the professional with a proactive approach to identifying and solving counterfeiting problems.

### Example 3

### Verifiable Bar Codes

The present invention may also be used in barcode technology. A bar code is a printed code on a product or package that can be optically read by a machine. Bar codes are used throughout the shipping, tracking and sales networks. Unfortunately, barcodes do little to verify the authenticity of a product because they are easily counterfeited. By adding a second compound to a dark ink that is already being used for barcode printing, a barcode that performs as expected that cannot be easily copied may be created. The presence of the second compound allows a professional to validate the authenticity of the code by using a camera or wand.

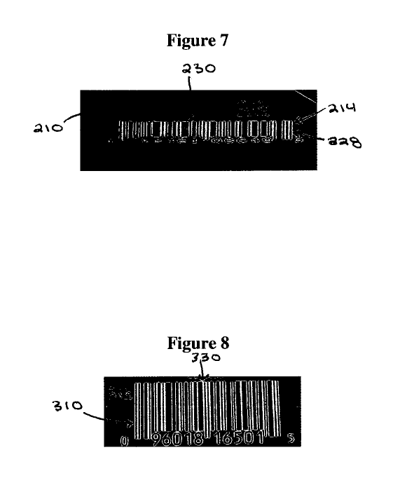

As seen in FIG. 7, an original barcode (230), reading “2346108610”, is printed on a substrate (216). The original barcode (230) is printed with black ink (228) that has a second compound (214) added to it. This original barcode (230) has a first image (210) that is machine-readable; the presence of the second compound (214) nay be verified using a detection device.

FIG. 8 contains a counterfeit barcode (330), reading “9601816501”, with a first image (310) that is machine-readable. This counterfeit barcode (330) is printed on the same substrate (216), but printed with ink that does not contain the second compound (214); therefore, when passed over this counterfeit barcode (330), the detection device should not detect a signal that is significantly different form the signal detected from the background.

The detection device measures the background (216) at 460 units. When scanned across the original barcode (230), shown in FIG. 7, the device measures 690 units. When scanned across the counterfeit barcode (330), shown in FIG. 8, the device measures 310 units. The original barcode (230) had a signal 50% brighter than the background alone and more than double the brightness of the counterfeit barcode (330). These differences would allow a professional to use the detection device or any other detection device to discriminate an original barcode with second compound from a counterfeit barcode. All this may be done without the consumer of the barcode knowing the difference.

As described above, the invention is directed to an authentication mark for application to a substrate, allowing a consumer to determine whether the product or product packaging is authentic. The mark may comprise a first image that a consumer can change between a first state and a second state. The mark may also contain a second image, which may be invisible to the consumer and may only be verified by using a detection device. The first and second images, may be applied in one or more locations on the product or product packaging and may completely overlie or partially intersect one another or be on distinct portions of product or product package.

The above-described embodiments or portions thereof are exemplary only and are not intended to be limiting. Rather, the present invention is directed to a mark wherein a consumer can change at least a portion of the mark between a first state and a second state by varying conditions. Additionally, but not required, the mark may also comprise a portion that may be verified with the use of a detection device, or more broadly, not verified by the consumer.

Having thus described certain embodiments of the present invention, various alterations, modification and improvements will readily occur to those skilled in the art. Such alterations, modifications, and improvements are intended to be within the spirit and scope of the invention. Accordingly, the foregoing description is by way of example only, and not intended to be limiting. In addition, the various elements described herein can be combined in any suitable manner, as the present invention is not limited in this respect. Therefore, the embodiments described above having particular combinations of elements are exemplary only. The invention therefore is limited only as defined in the following claims and the equivalent thereof.

What is claimed is:

1. An authentication mark to be applied to a substrate for aiding in the determination of whether the substrate is authentic, comprising:
a first image comprising a first compound, the first compound adapted to be altered by a consumer between at least a first state and a second state, wherein a change from the first state to the second state suggests that the substrate is authentic.

2. The authentication mark according to claim 1, wherein the change from the first state to the second state is a visual change.

3. The authentication mark according to claim 1, wherein the first state occurs under a first condition and the second state occurs under a second condition.

4. The authentication mark according to claim 3, wherein the first compound is thermochromic.

5. The authentication mark according to claim 4, wherein the first condition comprises a first temperature between approximately 18° C. and approximately 23° C. and the second condition comprises a second temperature at least one of below approximately 18° C. and above approximately 23° C.

6. The authentication mark according to claim 5, wherein when the first compound is in the first state, the first compound has a first appearance and when the first compound in the second state, the first compound has a second appearance, wherein the second appearance is different from the first appearance.

7. The authentication mark according to claim 6 wherein the first appearance is at least one of a first color, a first pattern, a first level of visibility and a first level of intensity and the second appearance is at least one of a second color, a second pattern, a second level of visibility and a second level of intensity.

8. The authentication mark according to claim 3, wherein the first compound is photochromic.

9. The authentication mark according to claim 8, wherein the first condition comprises a first light with a first wavelength within the range of approximately 400 nm to approximately 700 nm and the second condition comprises a second light with a second wavelength at least one of below approximately 400 nm and above approximately 700 nm.

10. The authentication mark according to claim 9, wherein when the first compound is in the first state, the first image has a first appearance and when the first compound in the second state, the first image has a second appearance, wherein the second appearance is different from the first appearance.

11. The authentication mark according to claim 10 wherein the first appearance is at least one of a first color, a first pattern, a first level of visibility and a first level of intensity and the second appearance is at least one of a second color, a second pattern, a second level of visibility and a second level of intensity.

12. The authentication mark according to claim 3, wherein the first compound is phosphorescent or fluorescent.

13. The authentication mark according to claim 12, wherein the first condition comprises a first intensity of light and the second condition comprises a second intensity of light, the second intensity of light being less than the first intensity of light.

14. The authentication mark according to claim 13, wherein the first compound in the first state does not visibly glow and the first compound in the second state visibly glows.

15. The authentication mark according to claim 1, wherein the first image is invisible when in the first state and the first image is visible when in the second state.

16. The authentication mark according to claim 1, wherein the first image is visible when in at least one of the first state and the second state.

17. The authentication mark according to claim 1, wherein the first image comprises at least a portion of one of a trademark, letter, number, logo and barcode.

18. The authentication mark according to claim 1, in combination with the substrate.

19. The combination according to claim 18, wherein the substrate is a product or product packaging.

20. The authentication mark according to claim 1, further comprising a second image comprising a second compound.

21. The authentication mark according to claim 20, wherein the second image is not visible to the naked eye.

22. The authentication mark according to claim 20, wherein the second compound, in response to irradiating light, absorbs or em its wavelengths outside the visible range.

23. The authentication mark according to claim 22, wherein the second compound is phosphorescent or fluorescent.

24. The authentication mark according to claim 20, wherein the second image comprises at least a portion of one of a trademark, letter, number, logo and barcode.

25. The authentication mark according to claim 20, wherein the first image is on a first portion of the substrate and the second image is on a second portion of the substrate.

26. The authentication mark according to claim 25, wherein the first portion of the substrate intersects with at least a portion of the second portion of the substrate.

27. The authentication mark according to claim 26, wherein the first portion of the substrate is the same as the second portion of the substrate.

28. The authentication mark according to claim 25, wherein the first portion of the substrate is separate from the second portion of the substrate.

29. An authentication mark to be applied to a substrate for aiding in the determination of whether the substrate is authentic, comprising:
a first image comprising a first compound, the first compound adapted to be altered by a consumer between at least a first state and a second state, wherein a change from the first state to the second state suggests that the substrate is authentic, and wherein the first compound is visible to the naked eye in at least one of the first and second states; and
a second image comprising a second compound, the second compound not being visible to the naked eye.

30. The authentication mark according to claim 29, wherein the first image is on a first portion of the substrate and the second image is on a second portion of the substrate.

31. The authentication mark according to claim 30, wherein the first portion of the substrate intersects with at least a portion of the second portion of the substrate.

32. The authentication mark according to claim 31, wherein the first portion of the substrate is the same as the second portion of the substrate.

33. The authentication mark according to claim 30, wherein the first portion of the substrate is separate from the second portion of the substrate.

34. A method of authenticating a substrate having an authentication mark on the substrate, wherein a consumer can perform at least a portion of an authentication, the mark comprising a first image, wherein a first compound is used to create at least a portion of the first image, the first compound adapted to be altered between at least a first state and a second state, the method comprising:
viewing the first image when the first compound is in the first state;
changing the first compound from the first state to the second state;
viewing the first image when the first compound is in the second state; and
determining whether the mark is authentic based on a change between the first and second states.

35. The method according to claim 34, further comprising:
viewing a second compound that is not visible to the naked eye through a detection device, the second compound being used to create a second image, the second image being at least a portion of the mark.

36. The method according to claim 34, further comprising:
applying the mark to the substrate.

37. The method according to claim 34, further comprising applying the mark with a printer.

38. The method according to claim 34, further comprising applying the mark with an inkjet printer.

39. The method according to claim 35, further comprising:
applying the first compound and the second compound simultaneously to the substrate.

40. The method according to claim 35, further comprising:
applying the first compound to the substrate at a different time than the second compound.

41. An authentication mark to be applied to a substrate for aiding in the determination of whether the substrate is authentic, comprising:
a first image comprising a hologram; and
a second image comprising a compound, the second image not being visible to the naked eye.

42. The authentication mark according to claim 41, wherein the hologram comprises at least two layers, wherein the second image is disposed between the layers.

43. The authentication mark according to claim 41, wherein the second compound, in response to irradiating light, absorbs or emits a wavelength of light outside the visible range.

44. The authentication mark according to claim 41, wherein the second compound is phosphorescent or fluorescent.
